(19) United States
(12) Patent Application Publication
(10) Pub. No.: US 2002/0074847 A1
(43) Pub. Date: Jun. 20, 2002

(54) Covering for protecting users of motor vehicle seat belts

(76) Inventor: Bill Terpselas, Brampton (CA)

Correspondence Address: DENNISON ASSOCIATES, Suite 301, 133 Richmond Street West, Toronto, ON, M5H 2L7, CA

(21) Appl. No.: 09/735,469

(22) Filed: Dec. 14, 2000

(51) Int. Cl. B60R 22/10

(52) U.S. Cl. 297/483; 297/482

(57) ABSTRACT

The present invention is directed to a protective covering for shoulder and lap seats belts of motor vehicles, the belts being connected together at a tongue releasably insertable into a latch of a buckle mechanism. The protective covering has a front and a back with a space therebetween for receiving the shoulder and lap belt. The covering has a generally truncated triangular shape with the front and back being joined together along two sides with the third side being open for receiving the shoulder and lap belt. The junction of the two joined sides is provided with an opening to permit the tongue of the seat belt to pass therethrough and engage the latch of the buckle. The covering is capable of distributing forces from the shoulder and lap belts over a larger area of the torso of a user upon the belts exerting a force on a user of the belt.

### FIELD OF THE INVENTION

The present invention relates to protective coverings to protect users of motor vehicle seat belts in the event the seat belt exerts a pressure on the torso of a user.

### BACKGROUND OF THE INVENTION

Seat belt usage as a safety measure for motor vehicles has been demonstrated for many years to have the potential to save lives in accidents if they are properly used. This has been recognized by governments with many jurisdictions making seat belt use mandatory for passengers of motor vehicles. In order to have the maximum benefit from the protective capability of seat belts, they must be properly used. This requires that the seat belt be properly adjusted so that the lap belt passes across the user's hips and not their abdomen. The shoulder belt should lay over the shoulder and across the chest with a slight space between the user and the belt. In addition, the shoulder belt should not be too low or too high or serious injury may result in an accident situation. While properly used, seat belts can prevent serious injury, in an accident situation, with the concentration of the forces in the web of the belt, injury of a user may still occur, albeit at a much lower level.

In some situations and especially with younger children, it may be difficult to properly adjust the seat belt. In many accident or fast stop situations, an improperly adjusted belt may itself cause injury An improperly adjusted lap belt which lies across the abdomen and not the hips could damage internal organs. Similarly, an improperly adjusted shoulder belt may cause broken bones such as the clavicle or ribs as well as the risk of punctured lungs or internal bleeding. There have been attempts in the past to provide seat belt adjusters to properly adjust the positioning of the seat belt, especially for young children. Examples of such adjusters are shown in U.S. Pat. No. 3,941,404; D349,589; U.S. Pat. Nos. 5,795,030; 6,086,158; 5,275,468; D424,785; and U.S. Pat. No. 5,265,910 among others. While many of these adjusters do allow for the proper positioning of the seat belt, they do have drawbacks. In many designs, it is necessary to readjust the seat belts to the proper position each time the belt is used. This makes it inconvenient to the user are reduces the likelihood of the user not using the adjuster. In addition, many designs do not allow for the distribution of the forces exerted by the seat belt over a larger area of the torso than just the narrow strips of the belts.

There thus remains a need for a simple to use seat belt adjust which increases the likelihood of the user using the adjuster and which will distribute the forces from the belts over a larger area of the torso of a user.

### SUMMARY OF THE INVENTION

The present invention is directed to a protective covering for shoulder and lap seats belts of motor vehicles, the belts being connected together at a tongue releasably insertable into a latch of a buckle mechanism. The protective covering has a front and a back with a space therebetween for receiving the shoulder and lap belt. The covering has a generally truncated triangular shape with the front and back being joined together along two sides with the third side being open for receiving the shoulder and lap belt. The junction of the two joined sides is provided with an opening to permit the tongue of the seat belt to pass therethrough and engage the latch of the buckle. The covering is capable of distributing forces from the shoulder and lap belts over a larger area of the tors of a user upon the belts exerting a force on a user of the belt.

### BRIEF DESCRIPTION OF THE DRAWINGS

Preferred embodiments of the present invention are illustrated in the attached drawings in which:

FIG. 1 is a perspective view of a preferred embodiment of the seat belt cover of the present invention in use by a user of a seat belt assembly;

FIG. 2 is a perspective view of a user of a seat belt assembly without the seat belt cover of the present invention;

FIG. 3 is a perspective view of the seat belt cover of FIG. 1; and

FIG. 4 is a perspective view partly in cross-section of the adjusting means for the shouldr belt of the seat belt cover of FIG. 1.

### DETAILED DESCRIPTION OF THE PREFERRED EMBODIMENTS

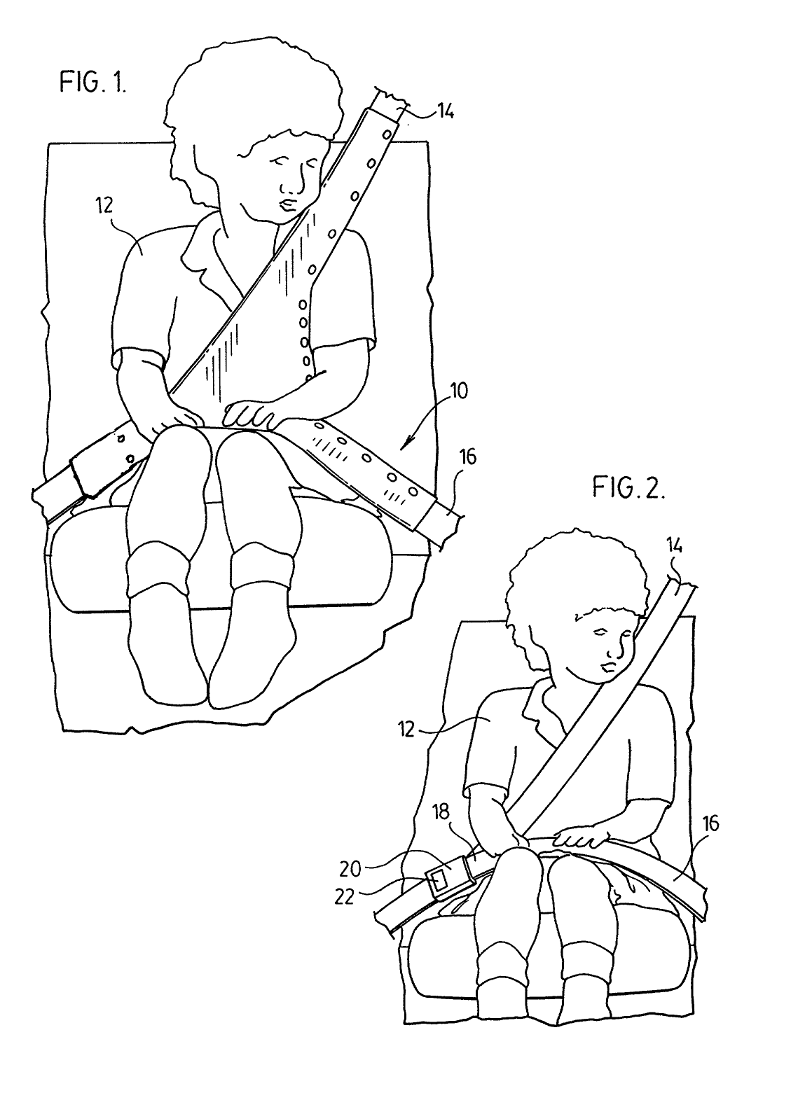

A preferred embodiment of a protective covering of the present invention is illustrated in the attached figures. As shown in FIG. 1, the seat belt cover 10 is of particular use with a small child 12, although, as will be described below, the cover 10 may be used by other persons. As shown in FIGS. 1 and 2, the typical motor vehicle seat belt assembly has a shoulder belt 14 and a lap belt 16 which are connected together at a tongue 18. The tongue 18 is releasably insertable into a latch 20 of the buckle assembly. The latch 20 is provided with a button 22 which when depressed, releases the tongue 18 from the latch 20. Without the seat belt covering of the present invention, as shown in FIG. 2, if the seat belts 14 and 16 exert a force on the user 12 of the belt in a sudden stop or accident situation, the force of the belts 14 nad 16, particularly the shoulder belt 14 is exerted over a narrow strip acrros the shoulder and torso of a user 12 The protective covering 10 encloses the shoulder belt 14 and lap belt 16 and provides for distribution of the forces which the belts 14 and 16 exert on a user to be spread over a larger area of the torso of a user 12 thus reducing the potential risk of injury by the user 12.

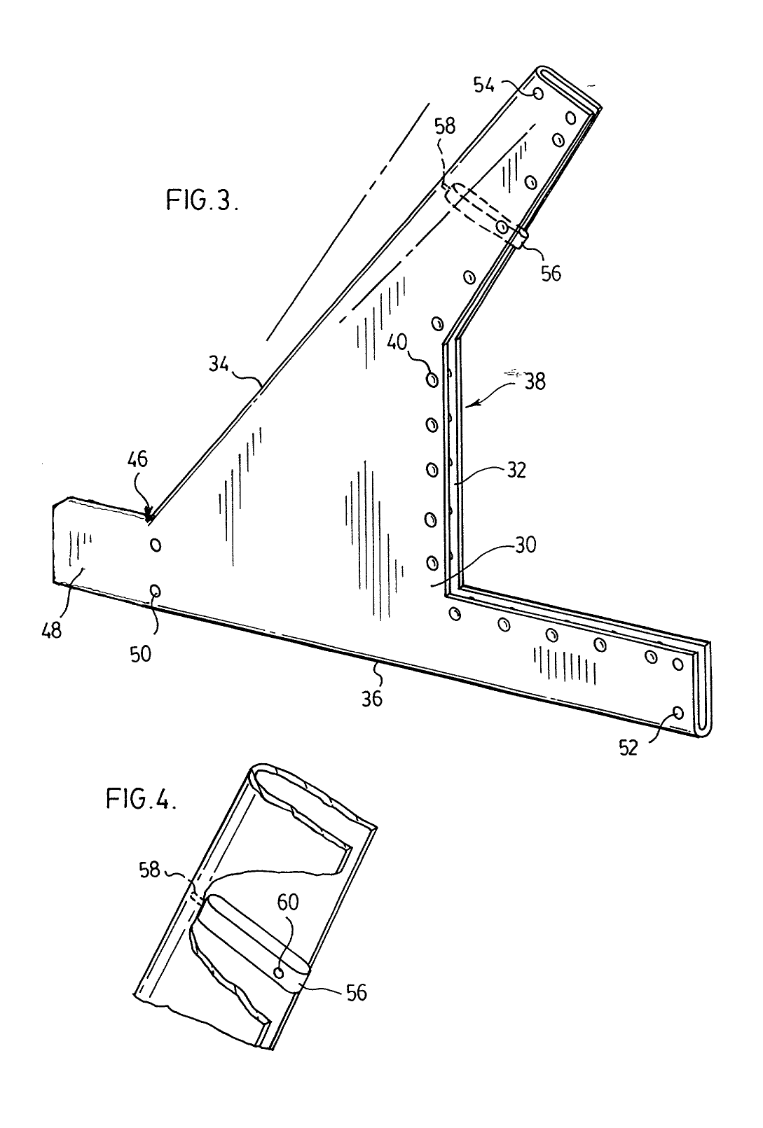

As illustrated in FIG. 3, the protective covering 10 has a generally A or truncated triangular shape. The covering has a front 30 and a back 32 with a space between them for receiving the shoulder belt 14 and lap belt 16. The front 30 and back 32 of the protective covering 10 are joined together along the two sides 34 and 36 against which the shoulder and lap belts will rest. The third side 38 is open to allow the shoulder and lap belts 14 and 16 to be inserted into the space between the front 30 and back 32. Preferably, the third open side is provided with a closure means to releasably close the side 38 after the shoulder and lap belts 14 and 16 have been inserted into the space between the front 30 and back 32. The closure means can be any of the commonly utilized releasable closure means such as buttons, zippers, hook and loop fasteners or dome snap fasteners to list just a few. Preferably, the closure are buttons, hook and loop fasteners and dome snap fasteners, more preferably, hook and loop fasteners and dome snap fasteners, most preferably, as shown in FIG. 3 and 4, the closure means are dome snap fasteners 40.

The junction between the two joined sides 34 and 36 is provided with an opening 46 to permit the tongue 18 of the buckle assembly to pass therethrough and engage the latch 20. To provide for increased protection of the release button 22 from being accidentally depressed, the opening 46 is preferably provided with a cover 48 to cover the latch 20 and button 22. Preferably the cover 48 is an extension of the front 30 and back 32 of a size to enclose the latch 20. The cover 48 is sized to allow it to be pulled back slightly or to allow a user to insert a figer or thumb under the cover 48 to depress the release button 22 and release the tongue 18. Preferably, the cover 48 is sized to allow an adult to be able to reach the release button 22 but not a child. This can be achieved by providing the cover 48 with a length to cover the latch 20 and not allow a child to be able to pull back the cover 48 and reach the release button 22 with their fingers.

In order to improve the retention of the tongue 18 in the opening, the edge of the opening adjacent the two joined sides is preferably provided with a means to releasably hold the tongue 18 in position. The means to hold the tongue in position engages the tongue 18 where the shoulder and lap belts attach to the tongue. In this way, it is not necessary to reinsert the tongue 18 into the opening with every use. Rather, the tongue 18 is maintained in its position in the opening and the belt assembly and covering 10 can be easily placed in the proper position on the user 12 and the tongue 18 inserted into the latch 20.

The tongue 18 at the end closest to the belts 14 and 16 is generally provided with an upper and lower shoulder extending outwardly from the edge of the belt. The means to hold the tongue 18 in position engages these shoulders to prevent the tongue 18 from retracting through the interior of the covering 10 when it is released from the latch 20. Various structures can be used to engage the shoulders of the tongue such as elastic rings encircling the opening or releasable fasteners in the interior of the opening. The releasable fasteners are positioned in the opening to engage the shoulders when they are fastened and to allow the tongue to be inserted into and removed from the opening when they are released. The releasable fasteners may be selected from for example, dome snap fasteners, buttons, or loop and hook fasteners. Preferably, the releasable fasteners are dome snap fasteners 50.

The cover 48 may alternatively be provided as an attached on piece of a different material such as an elastic mesh which in addition to covering the latch 20 also helps hold the tongue 18 in position in the opening when the tongue 18 is disengaged from the latch 20.

The ends of the closed sides 34 and 36 through which the shoulder belt 14 and lap belt 16 pass are preferably provided with extensions to encircle the belts 14 and 16 and provide for increased cushioning of the belts 14 and 16. The extensions are of a length to completely cover the portions of the belts which pass over the user's body. The open side of the extensions adjacent the opening are also provided with releasable closure means 40 to aid in the retention of the belts 14 and 16 within the interior of the extensions. To further aid in the retention of the belts 14 and 16, the interior of the extensions may be provided with belt holding means such as an elastic material or dome snap fasteners 52 and 54 to grip and hold the belt in position.

As set out above, preferably, the seat belt covering 10 is provided with a means to adjust the spacing between the shoulder belt 14 and lap belt 16 to adapt the seat belt covering 10 to users 12 of varying heights. This is preferably accomplished by providing a tether 56 to encircle the shoulder belt 14. One end of the tether 56 is attached to the interior of the closed side 34, preferably located in the extension of the closed side 34. The tether 56 is attached to the closed side by an elastic material 58 which allows the tether 56 to be extended from the interior of the covering 10. The second end of the tether is provided with complementary parts 60 of the closure means such as the dome fasteners 40 used to close the opening 38. In this way, the tether is attached to the closure means 40 of the opening 38. To adjust the spacing of the shoulder belt 14 and lap belt 16, the specific closure means 40 is selected to give the proper spacing. To make the spacing smaller, the tether 56 is fastened to a closure means 40 lower in the opeening 38, while to increase the spacing, a closure means 40 higher up in thye opening 38 is selected.

The seat belt covering of the present invention may be constructed of any suitable material. Preferably, for long life, the covering is constructed of a cover material which has a high resistance to wear. Suitable such materials include many synthetic or natural materials such as polyester, nylon, cotton, etc. More preferably, the cover of the seat belt protective covering of the present invention is constructed of nylon, most preferably, high wear resistant nylon such as rip stop nylon or ballistic nylon. To increase the cushioning ability of the protective covering of the present invention, the covering is provided with a suitable cushioning material such as foam to allow for better distribution of forces over the torso of a user. Preferably, the foam is a high density closed cell foam material to provide for some stiffness to the protective covering while at the same time providing the desired cushioning. More preferably, the foam cushioning material is provided in both the front and back sections, sandwiched between the outer covering and an inner lining which protects the foam from direct contact with the shoulder and lap belts. The stiffness of the covering may be varied by varying the density of the foam used in the covering.

If desired, to increase the distribution of forces over the torso of a user, the seat belt protective covering of the present invention may also be provided with a stiffer material in the back or in both the back and front sections. The stiffer material is preferably a sheet of polyolefin such as polyethylene or polypropylene or copolymers thereof. The thickness of the stiffer material is chosen to still provide some flexibility so there is some give to the material when a force is exerted on it. The stiffer material is smaller in size than the back or front sections and is sandwiched between foam sheets of a larger size to increase the cushioning and present no hard edges to a user.

The seat belt protective covering of the present invention provides for numerous advantages over prior designs of protective coverings for seat belts. Firstly, the seat belt protective covering of the present invention is capable of distributing forces from the shoulder and lap belts over a larger area of the torso of a user upon the belts exerting a force on a user of the belt. This reduces the potential for injury to a user because of the forces exerted by the belts are no longer being concentrated on a relatively small area of the body. This is particularly true for smaller users of the protective covering such as children.

The seat belt covering of the present invention also results in increased usage as compared to prior designs as the covering remains associated with the belts when the tongue of the belts is disengaged from the buckle. As the covering remains with the belts and the tongue remains easily accessible for insertion into the latch, the simple act of a user buckling up properly positions the covering. It is no longer necessary to feed the belt assembly through the covering each time it is desired to use the covering.

The seat belt covering of the present invention is simple to manufacture, in the preferred embodiment being constructed of closed cell foam sandwiched between layers of nylon which can be easily joined together by gluing, fusing or sewing.

Although various preferred embodiments of the present invention have been described herein in detail, it will be appreciated by those skilled in the art that variations may be made thereto without departing from the spirit of the invention or the scope of the attached claims.

I claim:

1. A protective covering for shoulder and lap seats belts of motor vehicles, the belts being connected together at a tongue releasably insertable into a latch of a buckle mechanism, the protective covering comprising:
a front and a back with a space therebetween for receiving the shoulder and lap belt,
the covering having a generally truncated triangular shape with the front and back being joined together along two sides with the third side being open for receiving the shoulder and lap belt,
the junction of the two joined sides being provided with an opening to permit the tongue of the seat belt to pass therethrough and engage the latch of the buckle,
the covering being capable of distributing forces from the shoulder and lap belts over a larger area of the torso of a user upon the belts exerting a force on a user of the belt.

2. A protective covering according to claim 1 wherein the third side is provided with releasable securing means to permit the front and back to be releasably secured to one another after the belts are received therebetween.

3. A protective covering according to claim 2 wherein the releasable securing means are selected from the group consisting of zipper closures, hook and loop closures, dome fasteners and buttons.

4. A protective covering according to claim 3 wherein the releasable securing means are dome fasteners.

5. A protective covering according to claim 4 wherein the dome fasteners permit the adjustment of the size of the open side to vary the spacing between the shoulder and lap belts to accommodate different sizes of users.

6. A protective covering according to claim 5 wherein the opening between the two joined sides is provided with a means for retaining the tongue portion in position in the opening between when released from the latch.

7. A protective covering according to claim 6 wherein the means for retaining the tongue is selected from dome fasteners or an elastic ring positioned to engage the tongue at the junction with the shoulder and lap belts.

8. A protective covering according to claim 7 wherein the opening between the two joined sides is provided with an elastic mesh cover to cover the latch release button when the tongue engages the latch of the buckle.
